(19) United States
(12) Patent Application Publication
(10) Pub. No.: US 2008/0031607 A1
(43) Pub. Date: Feb. 7, 2008

(54) Burglar alarm monitoring apparatus

(76) Inventor: Yi-Chia Liao, Miaoli County (TW)

Correspondence Address: BIRCH STEWART KOLASCH & BIRCH, PO BOX 747, FALLS CHURCH, VA, 22040-0747, US

(21) Appl. No.: 11/496,622

(22) Filed: Aug. 1, 2006

(51) Int. Cl. G03B 17/00

(52) U.S. Cl. 396/59

(57) ABSTRACT

A burglar alarm monitoring apparatus to activate a digital camera to take pictures includes a body, a receiver, an actuation means and a monitor device. The body has a housing chamber to hold the digital camera. The monitor device can detect intrusion of burglars and generate a detection signal which is sent to the receiver to trigger the actuation means to activate the digital camera, and then the digital camera starts taking pictures or video recording. Thus the digital camera can provide burglar alarm and monitor functions and has greater practicality.

### FIELD OF THE INVENTION

The present invention relates to a burglar alarm monitoring apparatus and particularly to a burglar alarm monitoring apparatus that is connected to a digital camera to receive intruding signals and activate the digital camera to take pictures and video recording.

### BACKGROUND OF THE INVENTION

To ensure security of houses, many image capturing devices such as monitors and video cameras have been installed in residence environments, such as hallways, parlors, living rooms and the like. In case of special events occur, such as intrusion of burglars, the images of the events can be captured and recorded to facilitate later investigation.

Professional image capturing equipments usually are expensive. Taken into account of economic effectiveness, they are mostly installed in important locations such as register counters, safety vaults and chests, banks, etc. They are rarely used in ordinary homes. With advance of technology, the price of digital cameras drops constantly and is more affordable to general public now. Many houses have one or more digital cameras these days. The present digital cameras mostly can take pictures one by one and dynamic video recording. They also can capture and store images. Hence the present invention aims to provide a burglar alarm monitoring apparatus for household use that employs a digital camera to enhance the added value of the digital camera and also provide a low cost monitoring for household environment to improve security.

### SUMMARY OF THE INVENTION

The primary object of the present invention is to provide a burglar alarm monitoring apparatus that is linked to a digital camera. The apparatus can activate the digital camera to take pictures or video recording.

The burglar alarm monitoring apparatus of the invention aims to activate a digital camera to take pictures. The digital camera has a shutter button. The apparatus includes a body, a monitor device, a receiver and an actuation means. The body has a housing chamber to hold the digital camera. The receiver and the actuation means are located on the body. The monitor device can detect unknown objects in a surveillance area and generate a detection signal. The receiver receives the surveillance signal and triggers the actuation means to activate the digital camera to take pictures.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is an exploded view of a first embodiment of the invention.

FIG. 2 is a schematic view of the first embodiment of the invention.

FIG. 3 is an exploded view of a second embodiment of the invention.

FIG. 4 is a schematic view of another embodiment of the invention.

### DETAILED DESCRIPTION OF THE PREFERRED EMBODIMENTS

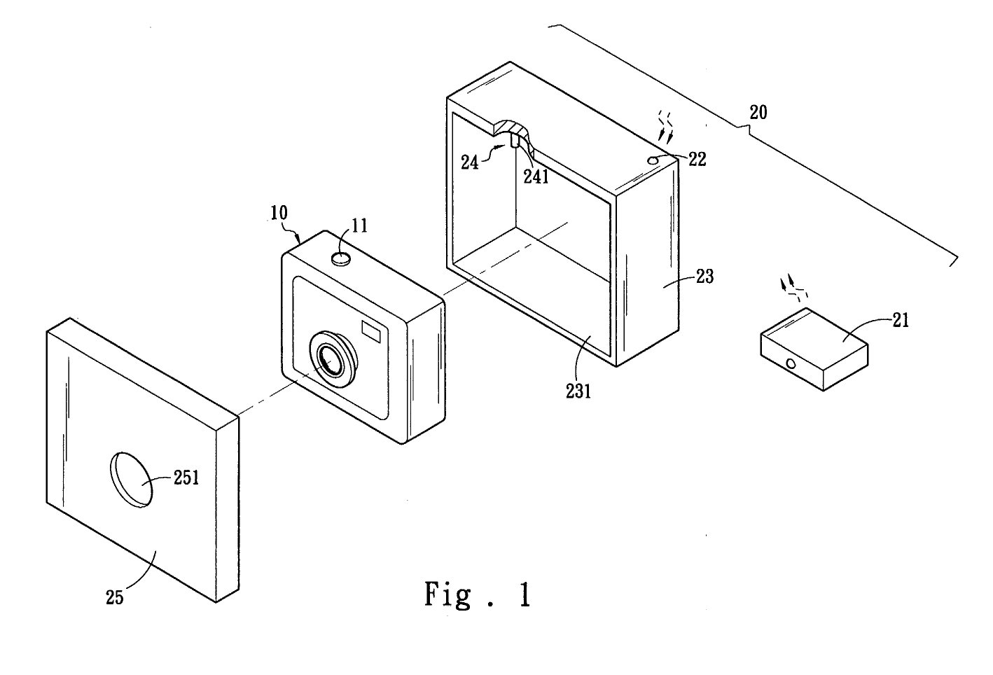

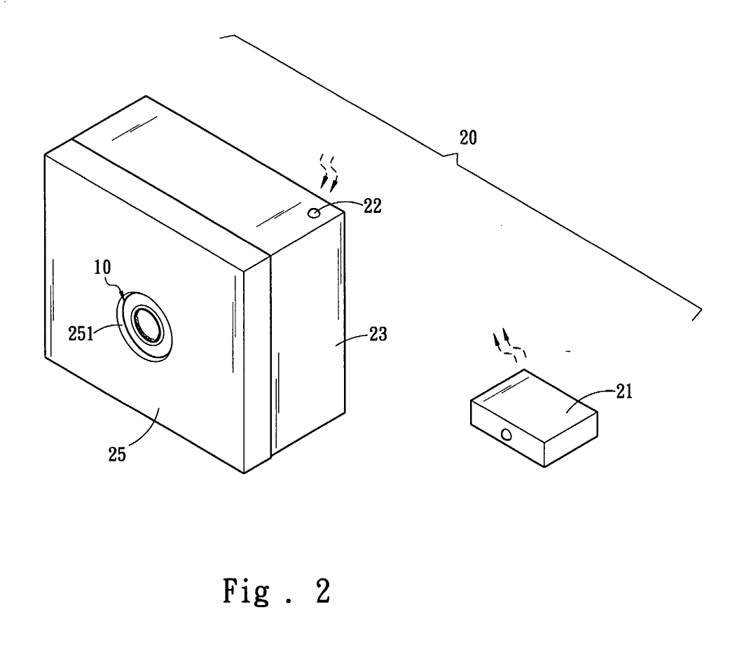

Please refer to FIGS. 1 and 2 for a first embodiment of the invention. The burglar alarm monitoring apparatus 20 of the invention aims to guard against burglars and perform monitoring. It is used to activate a digital camera 10 to take pictures. The digital camera 10 has a shutter button 11. When the digital camera 10 is started and enters a power saving mode (or sleeping mode), depressing the shutter button 11 can activate the digital camera 10 to take still pictures or dynamic video recording (these functions are provided by most digital cameras now on the marker, other functions are omitted).

The burglar alarm monitoring apparatus 20 of the invention includes a body 23, a monitor device 21, a receiver 22 and an actuation means 24. The body 23 has a housing chamber 231 to hold the digital camera 10. The actuation means 24 has a first extensible strut 241 located on a desired location in the housing chamber 231. The extensible strut 241 is movable through a magnetic force or rotation of a magnetic wheel generated by electromagnetic induction. Take electromagnetic induction as an example, it mainly includes a coil (not shown in the drawings) and a magnet (also not shown in the drawings). When the coil is energized by electricity, a magnetic force is generated. According to the direction of the magnetic force, varying attracting force or repulsive force is generated to urge the first extensible strut 241 to extend outwards or retract inwards. As the first extensible strut 241 may be adjusted such that the extended position is corresponding to the shutter button 11, hence when the shutter button 241 is extended, it depresses the shutter button 11 to activate the digital camera 10 to take pictures.

Thus the digital camera 10 may be held in the housing chamber 231 and set to a sleeping mode after a selected time interval after being started. The housing chamber 231 has an opening covered by a lid 25 which has an opening 251 to expose the lens of the digital camera 10 so that the digital camera 10 can be hidden without exposing. The invention can be installed on a location where burglar alarm and monitoring are required. In the event that intruders enter the location, the monitor device 21 detects the intruders and generates a detection signal which is received by the receiver 22. Then the first extendible strut 241 is extended to depress the shutter button 11, and the digital camera 10 at the sleeping mode is switched to a picture taking condition. After a selected time interval, the extensible strut 241 depresses again, the shutter button 11 is activated again to take still pictures or dynamic video recording.

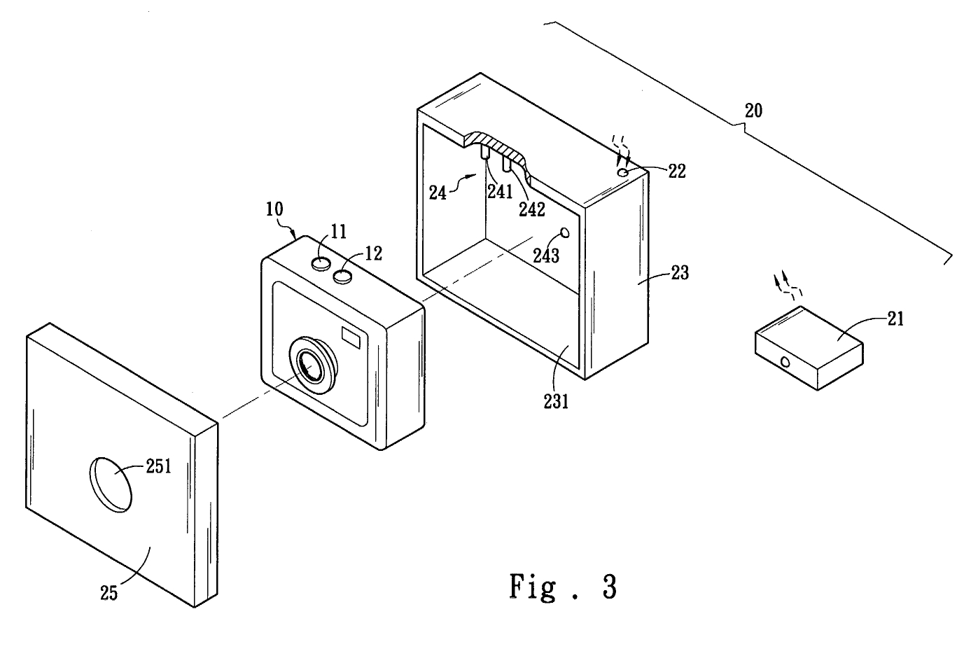

Refer to FIG. 3 for a second embodiment of the invention. The actuation means 24 includes the first extensible strut 241, a second extendible strut 242 and a photosensitive switch 243. The digital camera 10 has the shutter button 11 and a power switch 12 and an LCD device (not shown in the drawing). The power switch 12 is corresponding to the second extensible strut 242. This embodiment differs from the first embodiment by activating the digital camera with a different method.

In the second embodiment the digital camera 10 is located in the housing chamber 231 and also is covered by the lid 25 which has an opening 251, and is installed on a location where burglar alarm and monitoring is needed. In the event that intruders invade the location, the monitor device 21 detects the intrusion and generates a detection signal which is received by the receiver 22. The second extensible strut 242 is triggered to depress the power switch button 12 to activate the digital camera 10; the photosensitive switch 243 detects light emitted from the LCD device (namely to confirm that the digital camera 10 is started); then the first extensible strut 241 is triggered to depress the shutter button 11 to enable the digital camera 10 to take pictures or video recording.

The two embodiments previously discussed present only part of digital camera conditions. Due to a wide variety of digital cameras 10 are available nowadays, actuation method also varies. The actuation means 24 depicted in the invention may be altered to suit and activate different types of digital camera 10.

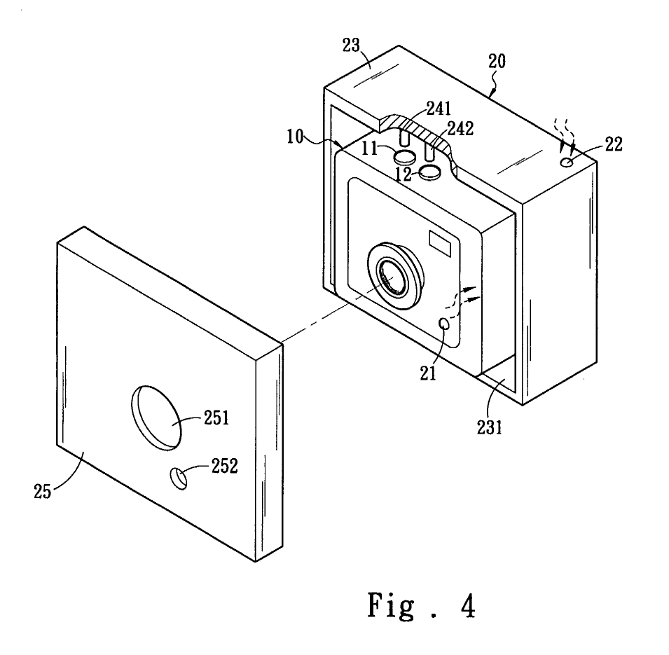

The receiver 22 and monitor device 21 of the invention may be connected and transmitted through a wireless or wired approach. The monitor device 21 may be an infrared detector or burglar alarm device to detect presence or moving of an unknown object to notice intrusion of burglars. Referring to FIG. 4, the monitor device 21 may be directly mounted onto the digital camera 10 to save installation trouble. The lid 25 has another aperture 252 to allow the monitor device 21 to monitor the selected location.

The housing chamber 231 can hold the digital camera 10 which is linked to the monitor device 21 through the receiver 22. When the monitor device 21 detects intrusion of burglars, the actuation means 24 activates the digital camera 10 to take still pictures or dynamic video recording. Thus the digital camera 10 of the invention not only can take pictures or video recording, also can provide burglar alarm and monitoring functions.

What is claimed is:

1. A burglar alarm monitoring apparatus to activate a digital camera to take pictures, comprising:
a body which has a housing chamber to hold the digital camera;
a monitor device installed in a monitoring location to detect unknown objects and generate a detection signal;
a receiver located on the body to receive the detection signal; and
an actuation means located on the body to activate the digital camera when the receiver receives the detection signal to allow the digital camera to take the pictures.

2. The burglar alarm monitoring apparatus of claim 1, wherein the digital camera has a shutter button, the actuation means has a first extendible strut corresponding to the shutter button, and the first extensible strut is extended outwards when the receiver receives the detection signal to depress the shutter button to actuate the digital camera to take the pictures.

3. The burglar alarm monitoring apparatus of claim 2, wherein the actuation means further includes a second extensible strut and a photosensitive switch, the digital camera further having a power switch and a LCD device, the power switch being corresponding to the second extensible switch, the second extensible switch depressing the power switch to activate the digital camera, and the photosensitive switch detecting light emitted from the LCD device to confirm a start condition of the digital camera then the first extensible strut depressing the shutter button.

4. The burglar alarm monitoring apparatus of claim 1, wherein the monitor device is an infrared human body detector.

5. The burglar alarm monitoring apparatus of claim 1, wherein the monitor device is a burglar alarm detector.

6. The burglar alarm monitoring apparatus of claim 1, wherein the receiver and the monitor device are linked by a wireless means.

7. The burglar alarm monitoring apparatus of claim 1, wherein the receiver and the monitor device are linked by a wired means.

8. The burglar alarm monitoring apparatus of claim 1 further having a lid to cover an opening of the housing chamber, the lid having an aperture.
